(19) United States
(12) Patent Application Publication
(10) Pub. No.: US 2026/0348327 A1
(43) Pub. Date: Nov. 5, 2026

(54) TRANSMISSION SYSTEM FOR A GAS TURBINE ENGINE OF AN AIRCRAFT PROPULSION SYSTEM

(71) Applicant: RTX Corporation, Farmington, CT (US)

(72) Inventors: Andrew E. Breault, Bolton, CT (US); Jeffrey T. Morton, Glastonbury, CT (US); Jon E. Sobanski, Glastonbury, CT (US)

(21) Appl. No.: 19/197,656

(22) Filed: May 2, 2025

(51) Int. Cl. F02C 7/36; F02C 7/32

(52) U.S. Cl. CPC F02C 7/36; F02C 7/32; F05D 2260/4031

(57) ABSTRACT

An aircraft propulsion system includes a gas turbine engine and a transmission system. The gas turbine engine includes a first rotating structure and a second rotating structure. The transmission system includes a gear assembly and a transmission. The gear assembly includes a first gear shaft and a second gear shaft. The first gear shaft and the second gear shaft are rotatable about a common lengthwise axis. The first gear shaft is coupled between the first rotating structure and the transmission. The second gear shaft is coupled between the second rotating structure and the transmission. The transmission is configurable in at least a first power transfer state and a second power transfer state. The transmission in the first power transfer state transfers power from the second rotating structure to the first rotating structure. The second power transfer state is a zero-power transfer state.

### BACKGROUND

### 1. Technical Field

This disclosure relates generally to aircraft propulsion systems and, more particularly, to transmission assemblies for aircraft propulsion system gas turbine engines.

### 2. Background Information

Various types and configurations of aircraft propulsion systems are known in the art including those with multiple-spool gas turbine engines. While these known aircraft propulsion systems have various benefits, there is still room in the art for improvement.

### SUMMARY

According to an aspect of the present disclosure, an aircraft propulsion system includes a gas turbine engine and a transmission system. The gas turbine engine includes a first rotating structure and a second rotating structure. The first rotating structure includes a bladed first compressor rotor and a bladed first turbine rotor. The second rotating structure includes a bladed second turbine rotor. The transmission system includes a gear assembly and a transmission. The gear assembly includes a first gear shaft and a second gear shaft. The first gear shaft and the second gear shaft have a concentric configuration. The first gear shaft and the second gear shaft are rotatable about a common lengthwise axis. The first gear shaft is coupled between the first rotating structure and the transmission. The second gear shaft is coupled between the second rotating structure and the transmission. The transmission is configurable in at least a first power transfer state and a second power transfer state. The transmission in the first power transfer state transfers power from the second rotating structure to the first rotating structure. The second power transfer state is a zero-power transfer state.

In any of the aspects or embodiments described above and herein, the transmission may be further configurable in a third power transfer state, and the transmission in the third power transfer state may transfer power from the first rotating structure to the second rotating structure.

In any of the aspects or embodiments described above and herein, the aircraft propulsion system may further include a propulsor rotor coupled with the second rotating structure.

In any of the aspects or embodiments described above and herein, the gas turbine engine may further include a fan case circumscribing the propulsor rotor, and the transmission may be mounted on the fan case.

In any of the aspects or embodiments described above and herein, the transmission may include a gear-based continuous variable transmission coupling the first gear shaft and the second gear shaft, and the gear-based continuous variable transmission may be configurable in a freewheeling condition in the zero-power transfer state.

In any of the aspects or embodiments described above and herein, the transmission may include a hydrodynamic torque converter coupling the first gear shaft and the second gear shaft.

In any of the aspects or embodiments described above and herein, the transmission system may further include a waste heat recovery system, the waste heat recovery system may include a heat exchanger, and the heat exchanger and the hydrodynamic torque converter may form a hydraulic fluid flow path.

In any of the aspects or embodiments described above and herein, the waste heat recovery system may further include a turbine, the turbine and the heat exchanger may form a secondary fluid flow path, and the turbine may be coupled with a mechanical load of the gas turbine engine.

In any of the aspects or embodiments described above and herein, the gas turbine engine may further include a combustor, the waste heat recovery system may further include a secondary fluid flow path, the heat exchanger may form a portion of the secondary fluid flow path, and the secondary fluid flow path may extend from the heat exchanger to the combustor.

In any of the aspects or embodiments described above and herein, the first rotating structure may include a bevel gear, the aircraft propulsion system may further include an accessory gear train and at least one accessory load, the accessory gear train may couple the at least one accessory load with the first rotating structure, the accessory gear train may be engaged with the bevel gear, and the first gear shaft may be engaged with the bevel gear.

In any of the aspects or embodiments described above and herein, the gear assembly may further include a third gear shaft and a fourth gear shaft, the third gear shaft and the fourth gear shaft may have a second concentric configuration, the third gear shaft and the fourth gear shaft may be rotatable about a second common lengthwise axis, the third gear shaft may be coupled between the first gear shaft and the transmission, and the fourth gear shaft may be coupled between the second gear shaft and the transmission.

In any of the aspects or embodiments described above and herein, the aircraft propulsion system may further include an accessory gear train and at least one accessory load, and the accessory gear train may couple the at least one accessory load with the third gear shaft.

In any of the aspects or embodiments described above and herein, the third gear shafts may extend through the transmission between the first gear shaft and the accessory gear train.

In any of the aspects or embodiments described above and herein, the second common lengthwise axis may be orthogonal to the common lengthwise axis.

According to another aspect of the present disclosure, an aircraft propulsion system includes a gas turbine engine, a transmission system, an accessory gear train, and at least one accessory load. The gas turbine engine includes a first rotating structure and a second rotating structure. The first rotating structure includes a bladed first compressor rotor, a bladed first turbine rotor, and a first gear. The second rotating structure includes a bladed second turbine rotor and a second gear. The transmission system includes a gear assembly and a transmission. The gear assembly includes a first gear shaft and a second gear shaft. The first gear shaft coupled between the first rotating structure and the transmission. The first gear shaft is engaged with the first gear. The second gear shaft is coupled between the second rotating structure and the transmission. The second gear shaft is engaged with the second gear. The accessory gear train is coupled between the first rotating structure and the at least one accessory load. The accessory gear train is engaged with the first gear.

In any of the aspects or embodiments described above and herein, the aircraft propulsion system may further include a propulsor rotor, the gas turbine engine may further include a fan case circumscribing the propulsor rotor, and the transmission may be mounted on the fan case.

In any of the aspects or embodiments described above and herein, the accessory gear train may include an accessory gear box, and the accessory gear box may be mounted on the fan case.

In any of the aspects or embodiments described above and herein, the first gear shaft and the second gear shaft may have a concentric configuration, and the first gear shaft and the second gear shaft may be rotatable about a common lengthwise axis.

According to another aspect of the present disclosure, an aircraft propulsion system includes a gas turbine engine, a transmission system, an accessory gear train, and at least one accessory load. The gas turbine engine includes a first rotating structure and a second rotating structure. The first rotating structure includes a bladed first compressor rotor and a bladed first turbine rotor. The second rotating structure includes a bladed second turbine rotor. The transmission system includes a gear assembly and a transmission. The gear assembly includes a first gear shaft and a second gear shaft. The first gear shaft is coupled between the first rotating structure and the transmission. The first gear shaft extends radially between and to a first inner end and a first outer end. The first inner end is disposed at the first rotating structure. The first outer end is disposed at the transmission. The second gear shaft is coupled between the second rotating structure and the transmission. The second gear shaft extends radially between and to a second inner end and a second outer end. The second inner end is disposed at the second rotating structure. The second outer end is disposed at the transmission. The accessory gear train is coupled between the first rotating structure and the at least one accessory load independent of the gear assembly.

In any of the aspects or embodiments described above and herein, the transmission may be configurable in at least a first power transfer state and a second power transfer state, the transmission in the first power transfer state may transfer power from the second rotating structure to the first rotating structure, and the second power transfer state may be a zero-power transfer state.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 illustrates a perspective view of an aircraft including propulsion systems, in accordance with one or more embodiments of the present disclosure.

FIG. 2 schematically illustrates a cutaway, side view of a propulsion system, in accordance with one or more embodiments of the present disclosure.

FIG. 3 schematically illustrates a cutaway, side view of the propulsion system including a gas turbine engine and a transmission system, in accordance with one or more embodiments of the present disclosure.

FIG. 4 schematically illustrates another view of the propulsion system of FIG. 3, in accordance with one or more embodiments of the present disclosure.

FIGS. 5A-B schematically illustrates cutaway, side views of the propulsion system including other transmission systems, in accordance with one or more embodiments of the present disclosure.

FIG. 6 schematically illustrates a cutaway, side view of the propulsion system including a gas turbine engine and yet another transmission system, in accordance with one or more embodiments of the present disclosure.

FIG. 7 schematically illustrates a cutaway, side view of the propulsion system including a gas turbine engine and yet another transmission system, in accordance with one or more embodiments of the present disclosure.

FIG. 8 schematically illustrates a cutaway, side view of the propulsion system including a gas turbine engine and yet another transmission system, in accordance with one or more embodiments of the present disclosure.

FIGS. 9A-B schematically illustrate waste heat recovery systems for a transmission system, in accordance with one or more embodiments of the present disclosure.

### DETAILED DESCRIPTION

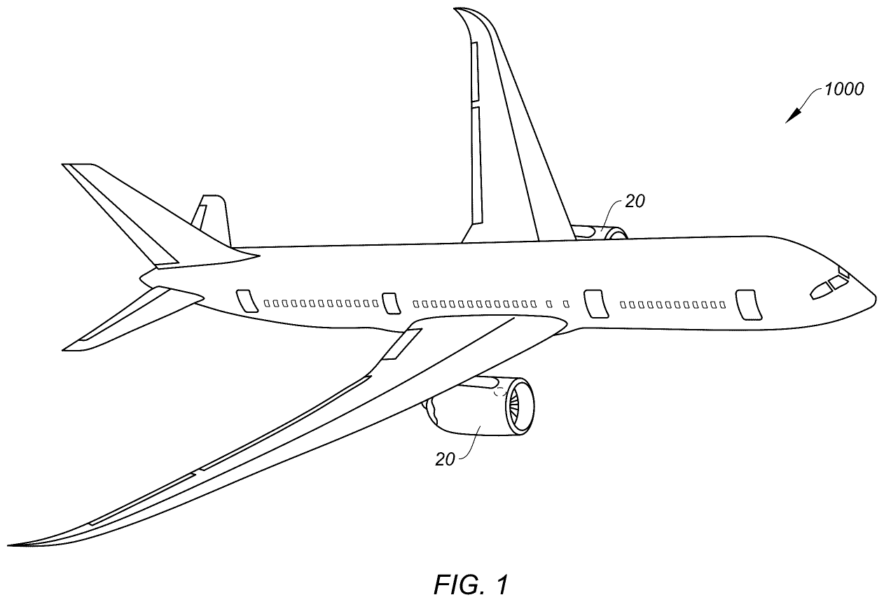

FIG. 1 illustrates an exemplary aircraft 1000 including a propulsion system 20. Briefly, the aircraft may be a fixed-wing aircraft (e.g., an airplane), a rotary-wing aircraft (e.g., a helicopter), a tilt-rotor aircraft, a tilt-wing aircraft, or another aerial vehicle. Moreover, the aircraft may be a manned aerial vehicle or an unmanned aerial vehicle (UAV; e.g., a drone).

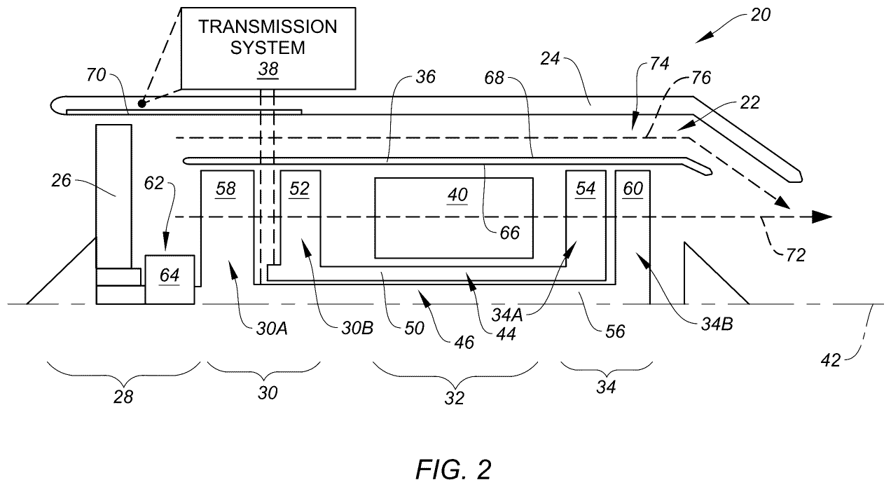

FIG. 2 schematically illustrates a cutaway, side view of the propulsion system 20. The propulsion system 20 of FIG. 2 includes a gas turbine engine 22, a nacelle 24, and a propulsor rotor 26 (e.g., a fan rotor, a propeller, an open rotor, an air mover, etc.). The gas turbine engine 22 of FIG. 2 is configured as a multi-spool turbofan gas turbine engine. However, while the following description and accompanying drawings may refer to the turbofan gas turbine engine of FIG. 2 as an example, it should be understood that aspects of the present disclosure may be equally applicable to other types of gas turbine engines including, but not limited to, a turboshaft gas turbine engine, a turboprop gas turbine engine, a turbojet gas turbine engine, or a propfan (e.g., an open rotor) gas turbine engine.

The gas turbine engine 22 of FIG. 2 includes a fan section 28, a compressor section 30, a combustor section 32, a turbine section 34, an engine static structure 36, and a transmission system 38. The compressor section 30 includes a low-pressure compressor (LPC) section 30A and a high-pressure compressor (HPC) section 30B. The combustor section 32 includes a combustor 40 (e.g., an annular combustor). The turbine section 34 includes a high-pressure turbine (HPT) section 34A and a low-pressure turbine (LPT) section 34B. The compressor section 30, the combustor section 32, and the turbine section 34 form an engine core of the gas turbine engine. The gas turbine engine 22 extends axially along a propulsion system axis 42 between an upstream, forward end of the propulsion system 20 and a downstream, aft end of the propulsion system. The axis 42 may be a centerline axis of the gas turbine engine 22 and/or a centerline axis of one or more members of the gas turbine engine 22. The axis 42 may also or alternatively be a rotational axis of one or more members of the gas turbine engine 22. The propulsor rotor 26 may be rotatable about the axis 42. Alternatively, the propulsor rotor 26 may be rotatable about another rotational axis which is (e.g., laterally and/or angularly) offset from the axis 42.

Components of the compressor section 30 and the turbine section 34 form a first rotating structure 44 (e.g., a high-pressure spool) and a second rotating structure 46 (e.g., a low-pressure spool) of the gas turbine engine 22. The gas turbine engine 22 of FIG. 2 is described herein with a particular two rotating structure arrangement. The present disclosure, however, is not limited to such an exemplary arrangement. For example, the bladed second compressor rotor 58 may be omitted to configure the bladed second turbine rotor 60 as a power turbine (PT) rotor for the propulsor rotor 26. In another example, the gas turbine engine 22 may also include another rotating structure (e.g., an intermediate speed spool).

The first rotating structure 44 includes a first shaft 50, a bladed first compressor rotor 52 for the high-pressure compressor 30B section, and a bladed first turbine rotor 54 for the high-pressure turbine section 34A. The first shaft 50 interconnects the bladed first compressor rotor 52 and the bladed first turbine rotor 54. This first rotating structure 44 of FIG. 2 and its members 50, 52, 54 are rotatable about the axis 42. However, in other embodiments, the first rotating structure 44 and its members 50, 52, 54 may alternatively be rotatable about another rotational axis which is (e.g., laterally and/or angularly) offset from the axis 42.

The second rotating structure 46 includes a second shaft 56, a bladed second compressor rotor 58 for the low-pressure compressor 30A section, and a bladed second turbine rotor 60 for the low-pressure turbine section 34B. The second shaft 56 interconnects the bladed second compressor rotor 58 and the bladed second turbine rotor 60. This second rotating structure 46 of FIG. 2 and its members 56, 58, 60 are rotatable about the axis 42. However, in other embodiments, the second rotating structure 46 and its members 56, 58, 60 may alternatively be rotatable about another rotational axis which is (e.g., laterally and/or angularly) offset from the axis 42. The second rotating structure 46 of FIG. 2 is oriented concentric with the first rotating structure 44 (e.g., relative to the axis 42).

The second rotating structure 46 is coupled to the propulsor rotor 26 through a drivetrain 62. This drivetrain 62 may be configured as a geared drivetrain, where a geartrain 64 (e.g., a transmission, a speed change device, an epicyclic geartrain, etc.) is disposed between and operatively couples the propulsor rotor 26 to the second rotating structure 46. With this arrangement, the propulsor rotor 26 may rotate at a different (e.g., slower) rotational speed than the second rotating structure 46. Alternatively, the drivetrain 62 may be configured as a direct-drive drivetrain, where the geartrain 64 is omitted. With such an arrangement, the propulsor rotor 26 rotates at a common (the same) rotational speed as the second rotating structure 46.

The engine static structure 36 may include one or more engine cases, cowlings, bearing assemblies, and/or other non-rotating structures configured to house and/or support (e.g., rotationally support) components of the gas turbine engine 22 sections 28, 30, 32, 34. The engine static structure 36 of FIG. 2 includes an engine case assembly 66, a core cowl structure 68, and a fan case 70. The engine case assembly 66 houses and supports components of the engine core sections 30, 32, 34. The engine case assembly 66 forms a core flow path 72 through the gas turbine engine 22. The core cowl structure 68 is disposed radially outward of the engine case assembly 66. The core cowl structure 68 forms an exterior housing of the gas turbine engine 22. The core cowl structure 68 forms an annular bypass duct 74 (e.g., an inner radial portion of the bypass duct 74) through the propulsion system 20, which bypass duct forms a bypass flow path 76. The fan case 70 of FIG. 2 is disposed radially outward of and circumscribes the propulsor rotor 26. The fan case 70 may further form an outer radial portion of the bypass duct 74.

As will be discussed in further detail, the transmission system 38 is operably coupled with and between the first rotating structure 44 (e.g., the first shaft 50) and the second rotating structure 46 (e.g., the second shaft 56). The transmission system 38 is configured to facilitate mechanical power transfer from the first rotating structure 44 to the second rotating structure 46 and/or from the second rotating structure 46 to the first rotating structure 44.

The nacelle 24 forms an exterior, aerodynamic housing of the propulsion system 20 and its gas turbine engine 22. The nacelle 24 extends circumferentially about (e.g., completely around) the gas turbine engine 22 and the axis 42. The nacelle 24 forms and circumscribes the fan case 70 and the bypass duct 74.

In operation of the propulsion system 20 of FIG. 2, ambient air is directed through the fan section 28 and into the core flow path 72 and the bypass flow path 76. Airflow along the core flow path 72 is compressed in the low-pressure compressor section 30A and the high-pressure compressor section 30B, mixed and burned with fuel in the combustor 40, and then directed through the high-pressure turbine section 34A and the low-pressure turbine section 34B. The bladed first turbine rotor 54 and the bladed second turbine rotor 60 rotationally drive the first rotating structure 44 and the second rotating structure 46, respectively, in response to the combustion gas flow through the turbine section 34.

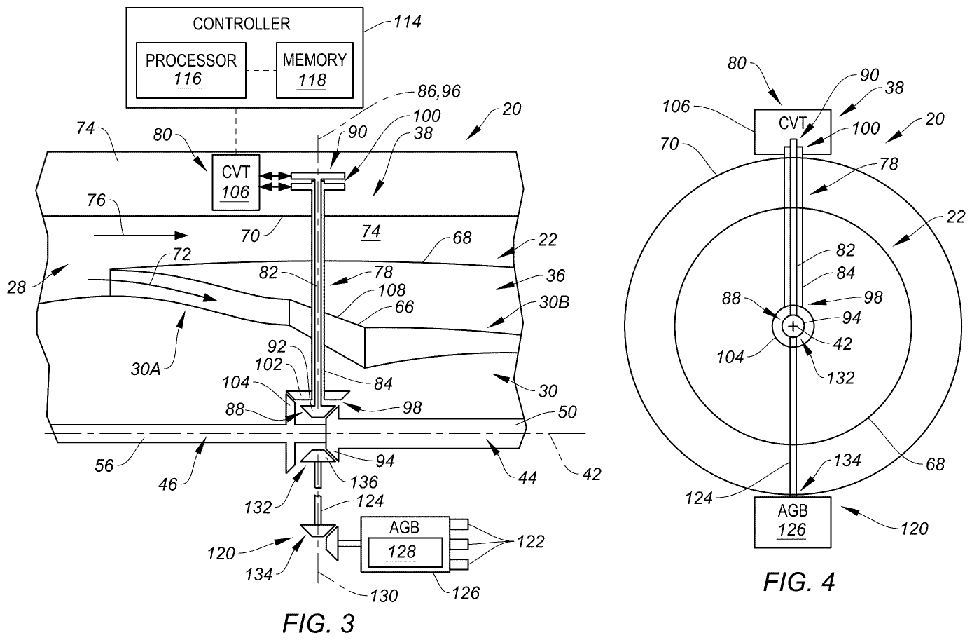

FIGS. 3 and 4 schematically illustrate the propulsion system 20 showing the transmission system 38 in greater detail. FIG. 3 schematically illustrates a cutaway, side view of the propulsion system 20 with the bladed first compressor rotor 52 and the bladed second compressor rotor 58 omitted for clarity. FIG. 4 schematically illustrates the transmission system 38 along a plane orthogonal to the axis 42. The transmission system 38 includes a gear assembly 78 and a transmission 80.

The gear assembly 78 of FIGS. 3 and 4 includes a first gear shaft 82 and a second gear shaft 84. The first gear shaft 82 is coupled with and between the first rotating structure 44 (e.g., the first shaft 50) and the transmission 80. The second gear shaft 84 is coupled with and between the second rotating structure 46 (e.g., the second shaft 56) and the transmission 80. The first gear shaft 82 and the second gear shaft 84 of FIGS. 3 and 4 have a bevel gear arrangement with the first rotating structure 44 and the second rotating structure 46, respectively. The present disclosure, however, is not limited to this foregoing exemplary arrangement of the first gear shaft 82 and the second gear shaft 84.

The first gear shaft 82 extends along a lengthwise axis 86 between a first end 88 of the first gear shaft 82 and a second end 90 of the first gear shaft 82. The axis 86 is oriented substantially orthogonal to the axis 42 such that the first gear shaft 82 extends radially outward from the first rotating structure 44. The first gear shaft 82 is coupled with the first rotating structure 44 at (e.g., on, adjacent, or proximate) the first end 88. The first gear shaft 82 includes a bevel gear 92 at the first end 88. The bevel gear 92 is arranged circumferentially about the axis 86. The bevel gear 92 is engaged (e.g., meshed) with a bevel gear 94 of the first rotating structure 44. The bevel gear 94 is arranged circumferentially about the axis 42. The first gear shaft 82 is coupled with the transmission 80 at (e.g., on, adjacent, or proximate) the second end 90.

The second gear shaft 84 extends along a lengthwise axis 96 between a first end 98 of the second gear shaft 84 and a second end 100 of the second gear shaft 84. The axis 96 is oriented substantially orthogonal to the axis 42 such that the second gear shaft 84 extends radially outward from the second rotating structure 46. The first gear shaft 82 and the second gear shaft 84 of FIGS. 3 and 4 have a concentric configuration such that the axes 86, 96 form a common (e.g., same) lengthwise axis of the first gear shaft 82 and the second gear shaft 84. As shown in FIGS. 3 and 4, the second gear shaft 84 circumscribes the first gear shaft 82 along its length from the first end 98 to the second end 100. Of course, this arrangement of the first gear shaft 82 and the second gear shaft 84 may alternatively be reversed such that the first gear shaft 82 circumscribes the second gear shaft 84 along its length from the first end 88 to the second end 90. While the first gear shaft 82 and the second gear shaft 84 are shown in a concentric configuration, other arrangements of the first gear shaft 82 and the second gear shaft 84 relative to the transmission 80 are contemplated. For example, the first gear shaft 82 and the second gear shaft 84 may have a parallel configuration. Alternatively, for example, the first gear shaft 82 and the second gear shaft 84 may be arranged along a common axis, but displaced from one another along the common axis (e.g., the first gear shaft 82 and the second gear shaft 84 may be coupled to opposing axial ends of the transmission 80). The second gear shaft 84 is coupled with the second rotating structure 46 at (e.g., on, adjacent, or proximate) the first end 98. The second gear shaft 84 includes a bevel gear 102 at the first end 98. The bevel gear 102 is arranged circumferentially about the axis 96. The bevel gear 102 is engaged (e.g., meshed) with a bevel gear 104 of the second rotating structure 46. The bevel gear 104 is arranged circumferentially about the axis 42. The second gear shaft 84 is coupled with the transmission 80 at (e.g., on, adjacent, or proximate) the second end 100.

The transmission 80 couples the first gear shaft 82 and the second gear shaft 84 together. The transmission 80 is configured to selectively transfer power from the first gear shaft 82 to the second gear shaft 84 and/or from the second gear shaft 84 to the first gear shaft 82. The transmission 80 of FIGS. 3 and 4 includes a continuously variable transmission (CVT) 106 operable through a continuous range of gear ratios between the first gear shaft 82 and the second gear shaft 84. In particular, the continuously variable transmission 106 may be configured as an infinitely variable transmission (IVT) which is operable in a zero-power transfer state to transmit zero output speed from any given input speed. For example, the continuously variable transmission 106 may be configured as a gear-based CVT such as an epicyclic CVT (also known as a planetary CVT), which gear-based CVT may be selectively operable in a freewheeling state such that no power is transmitted between the first gear shaft 82 and the second gear shaft 84 in the zero-power transfer state. The continuously variable transmission 106 is operable over a continuous range of (e.g., positive and negative) gear ratios to transmit power from the first gear shaft 82 to the second gear shaft 84 and from the second gear shaft 84 to the first gear shaft 82. The continuously variable transmission 106 may be an oil cooled and lubricated system. For example, the continuously variable transmission 106 may be connected in fluid communication with an engine oil system of the gas turbine engine, which engine oil system may facilitate thermal management and lubrication of other engine oil loads such as the drivetrain 62 and its geartrain 64.

The first gear shaft 82 and the second gear shaft 84 of FIGS. 3 and 4 extend through the engine case assembly 66 and the core cowl structure 68. For example, the first gear shaft 82 and the second gear shaft 84 of FIGS. 3 and 4 extend through an intermediate case (IMC) 108 of the engine case assembly 66 forming a portion of the core flow path 72 between the low-pressure compressor section 30A and the high-pressure compressor section 30B.

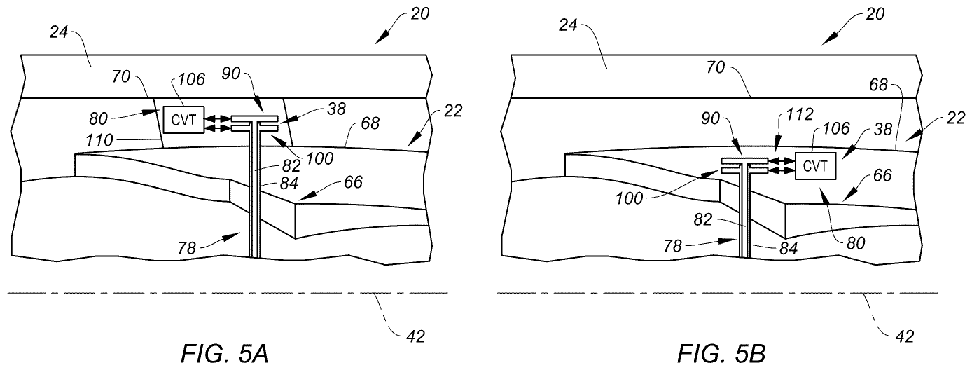

The transmission 80 of FIGS. 3 and 4 is disposed radially outboard of the gas turbine engine 22. In particular, the transmission 80 of FIGS. 3 and 4 is mounted on an exterior of the fan case 70 within the nacelle 24. The transmission 80 may be disposed at a top-dead-center position on the fan case 70; however, the present disclosure is not limited to any particular circumferential position of the transmission 80. The first gear shaft 82 and the second gear shaft 84 (e.g., tower shafts) extend radially from the rotating structures 44, 46 to the transmission 80 at the fan case 70. As shown in FIGS. 3 and 4, the second ends 90, 100 of the respective gear shafts 82, 84 are disposed radially outward of the fan case 70 at the transmission 80. This arrangement of the transmission system 38 facilitates locating the transmission 80 outside the engine core where packaging may be particularly challenging due to limited available space. The concentric configuration of the first gear shaft 82 and the second gear shaft 84 further reduce the footprint of the transmission system 38 within the propulsion system 20. The present disclosure, however, is not limited to the transmission 80 installed on the fan case 70. For example, as shown in FIG. 5A, the transmission 80 and the second ends 90, 100 may be disposed within a bifurcation structure 110 (e.g., an upper bifurcation) extending radially through the bypass duct 74 between the core cowl structure 68 and the fan case 70. Alternatively, as shown in FIG. 5B, the transmission 80 and the second ends 90, 100 may be disposed within a core compartment 112 of the gas turbine engine 22 between the engine case assembly 66 and the core cowl structure 68.

The propulsion system 20 may include a controller 114 connected in signal communication with the transmission 80 (e.g., an actuator of the transmission 80) to effect operation of the transmission 80 to transfer power from the first rotating structure 44 (e.g., the first gear shaft 82) to the second rotating structure 46 (e.g., the second gear shaft 84) or from the second rotating structure 46 (e.g., the second gear shaft 84) to the first rotating structure 44 (e.g., the first gear shaft 82), or to otherwise operate in the freewheeling state or another zero-power transfer state. The controller 114 includes a processor 116 connected in signal communication with memory 118. The processor 116 may include any type of computing device, computational circuit, processor(s), central processing unit (CPU), graphics processing unit (GPU), computer, or the like capable of executing a series of instructions that are stored in the memory 118. Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. The instructions may include an operating system, and/or executable software modules such as program files, system data, buffers, drivers, utilities, and the like. The executable instructions may apply to any functionality described herein to enable the controller 114 and its processor 116 to accomplish the same algorithmically and/or by coordination of transmission 80 components. The memory 118 may include a single memory device or a plurality of memory devices (e.g., a computer-readable storage device that can be read, written, or otherwise accessed by a general purpose or special purpose computing device, including any processing electronics and/or processing circuitry capable of executing instructions). The present disclosure is not limited to any particular type of memory device, which may be non-transitory, and may include read-only memory, random access memory, volatile memory, non-volatile memory, static memory, dynamic memory, flash memory, cache memory, volatile or non-volatile semiconductor memory, optical disk storage, magnetic disk storage, magnetic tape, other magnetic storage devices, or any other medium capable of storing one or more instructions, and/or any device that stores digital information. The memory device(s) may be directly and/or indirectly coupled to the controller 114. The controller 114 may include, or may be in communication with, a user interface including one or more inputs devices and/or one or more output devices, for example, an input device that enables a user to enter data and/or instructions and an output device configured to display information (e.g., a visual display or a printer), or to transfer data, etc. Communications between the controller 114 and external electrical or electronic devices may be via a hardwire connection or via a wireless connection. A person of skill in the art will recognize that portions of the controller 114 may assume various forms (e.g., digital signal processor, analog device, etc.).

The controller 114 may form or otherwise be part of an engine control unit (ECU) for the propulsion system 20. The ECU may control operating parameters of the gas turbine engine 22 including, but not limited to, fuel flow, compressor bleed air, shaft 50, 56 torque and/or rotation speed, etc. so as to control an engine power or performance of the gas turbine engine 22. In some embodiments, the ECU may be part of a full authority digital engine control (FADEC) system for the propulsion system 20.

The gas turbine engine 22 may further include an accessory gear train 120 arranged with the transmission system 38. The accessory gear train 120 couples the first rotating structure 44 with one or more accessory loads 122 of the gas turbine engine 22. Examples of the accessory loads 122 include generators, pumps, air compressors, engine starters, and the like, configured to be driven by the first rotating structure 44 through the accessory gear train 120. The accessory gear train 120 includes an accessory gear shaft 124 and an accessory gearbox (AGB) 126. The accessory gear shaft 124 is coupled with and between the first rotating structure 44 (e.g., the first shaft 50) and an accessory gear assembly 128 of the accessory gearbox 126. The accessory gear shaft 124 extends along a lengthwise axis 130 between a first end 132 of the accessory gear shaft 124 and a second end 134 of the accessory gear shaft 124. The axis 130 is oriented substantially orthogonal to the axis 42 such that the accessory gear shaft 124 extends radially outward from the first rotating structure 44. The accessory gear shaft 124 is coupled with the first rotating structure 44 at (e.g., on, adjacent, or proximate) the first end 132. The accessory gear shaft 124 includes a bevel gear 136 at the first end 132. The bevel gear 136 is arranged circumferentially about the axis 130. The bevel gear 136 is engaged (e.g., meshed) with the bevel gear 94 of the first rotating structure 44. The accessory gear shaft 124 is coupled with accessory gear assembly 128 at (e.g., on, adjacent, or proximate) the second end 134. The accessory gear assembly 128 is coupled with and between the accessory gear shaft 124 and the accessory loads 122. As shown in FIG. 4, the accessory gearbox 126 may be mounted to or otherwise disposed at the fan case 70 similar to the transmission 80. The accessory gearbox 126 may be positioned circumferentially opposite the transmission 80, for example, at a bottom-dead center circumferential position of the fan case 70.

In operation of the propulsion system 20 and its gas turbine engine 22, the transmission system 38 is configured to selectively transfer power from the first rotating structure 44 to the second rotating structure 46 and/or from the second rotating structure 46 to the first rotating structure 44. For example, during a low-power operating condition (e.g., ground idle, landing, or approach conditions) of the gas turbine engine 22, the transmission system 38 may transfer excess power from the second rotating structure 46 to the first rotating structure 44 to facilitate improved efficiency of the gas turbine engine 22. The configuration of the gear assembly 78 and the accessory gear train 120 facilitates power transfer between the first rotating structure 44 and the second rotating structure 46, by the transmission system 38, independent of the accessory gear train 120. The transmission system 38 may additionally facilitate improved performance and/or responsiveness of the propulsion system 20 during at least some operating conditions. For example, during a rapid acceleration transient, power transfer by the transmission system 38 from the first rotating structure 44 to the second rotating structure 46 may decrease time required for the propulsion system 20 to achieve maximum thrust. In another example, the transmission system 38 may transfer power from the second rotating structure 46 to the first rotating structure 44 to facilitate combustion start during an in-flight relight of the combustor 40 (see FIG. 2).

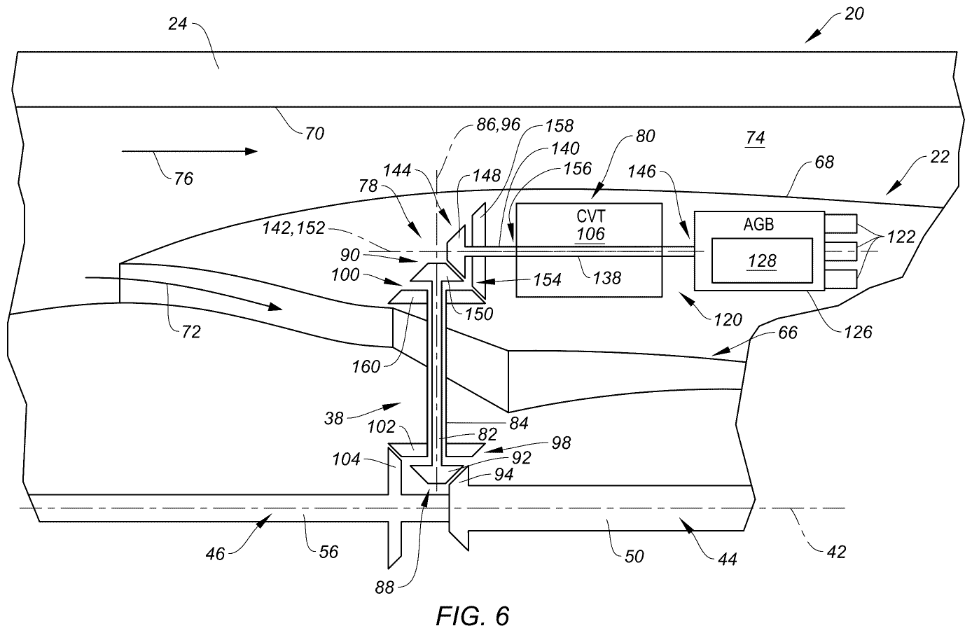

Referring to FIG. 6, in some embodiments, the gear assembly 78 may operably couple the first rotating structure 44 with both the transmission 80 and the accessory gearbox 126. The gear assembly 78 of FIG. 6 further includes a third gear shaft 138 and a fourth gear shaft 140. The third gear shaft 138 is coupled with and between the first gear shaft 82, the transmission 80, and the gearbox 126. The fourth gear shaft 140 is coupled with and between the second gear shaft 84 and the transmission 80. The third gear shaft 138 and the fourth gear shaft 140 of FIG. 6 have a bevel gear arrangement with the first gear shaft 82 and the second gear shaft 84, respectively. The present disclosure, however, is not limited to this foregoing exemplary arrangement of the third gear shaft 138 and the fourth gear shaft 140.

The third gear shaft 138 extends along a lengthwise axis 142 between a first end 144 of the third gear shaft 138 and a second end 146 of the third gear shaft 138. The axis 142 may be oriented substantially orthogonal to the axis 86 of the first gear shaft 82. The third gear shaft 138 is coupled with the first gear shaft 82 at (e.g., on, adjacent, or proximate) the first end 144. The third gear shaft 138 includes a bevel gear 148 at the first end 144. The bevel gear 148 is arranged circumferentially about the axis 142. The bevel gear 148 is engaged (e.g., meshed) with a bevel gear 150 of the first gear shaft 82. The bevel gear 150 is disposed at the second end 90 and arranged circumferentially about the axis 86. The third gear shaft 138 is coupled with the accessory gear assembly 128 at (e.g., on, adjacent, or proximate) the second end 146. Accordingly, the third gear shaft 138 may form a portion of the accessory gear train 120. The third gear shaft 138 is coupled with the transmission 80 on an intermediate portion of the third gear shaft 138 between the first end 144 and the second end 146. The third gear shaft 138 may extend through the transmission 80 along its axis 142.

The fourth gear shaft 140 extends along a lengthwise axis 152 between a first end 154 of the fourth gear shaft 140 and a second end 156 of the fourth gear shaft 140. The axis 152 may be oriented substantially orthogonal to the axis 96 of the second gear shaft 84. The third gear shaft 138 and the fourth gear shaft 140 of FIG. 6 have a concentric configuration such that the axes 142, 152 form a common (e.g., same) lengthwise axis of the third gear shaft 138 and the fourth gear shaft 140. As shown in FIG. 6, the fourth gear shaft 140 circumscribes the third gear shaft 138 along its length from the first end 154 to the second end 156. While the third gear shaft 138 and the fourth gear shaft 140 are shown in a concentric configuration, other arrangements of the third gear shaft 138 and the fourth gear shaft 140 relative to the transmission 80 and the accessory gearbox 126 are contemplated. For example, the third gear shaft 138 and the fourth gear shaft 140 may have a parallel configuration. Alternatively, for example, the third gear shaft 138 and the fourth gear shaft 140 may be arranged along a common axis, but displaced from one another along the common axis. The fourth gear shaft 140 is coupled with the second gear shaft 84 at (e.g., on, adjacent, or proximate) the first end 154. The fourth gear shaft 140 includes a bevel gear 158 at the first end 154. The bevel gear 158 is arranged circumferentially about the axis 152. The bevel gear 158 is engaged (e.g., meshed) with a bevel gear 160 of the second gear shaft 84. The bevel gear 160 is disposed at the second end 100 and arranged circumferentially about the axis 96. The fourth gear shaft 140 is coupled with the transmission 80 at (e.g., on, adjacent, or proximate) the second end 156.

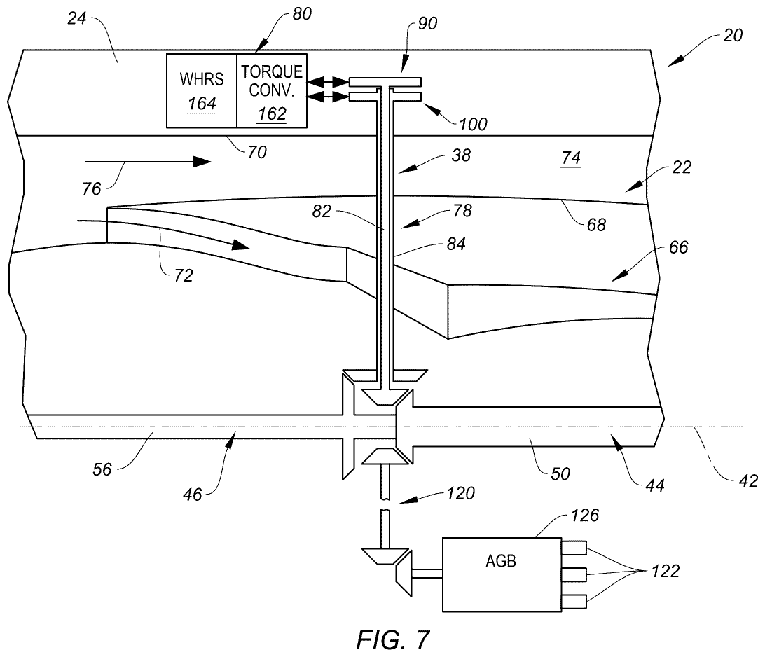

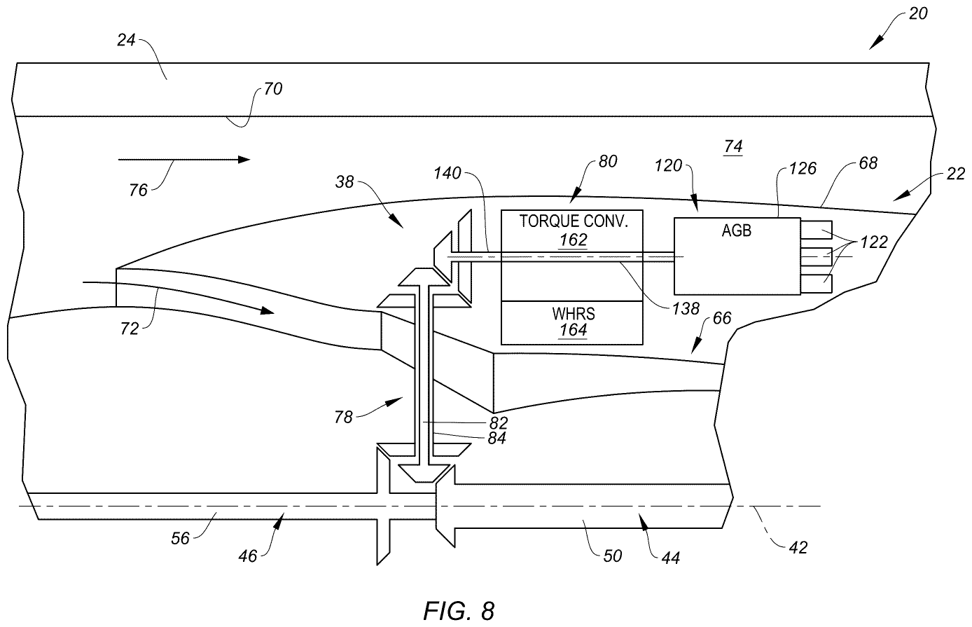

Referring to FIGS. 7 and 8, in some embodiments, the transmission 80 may alternatively include a torque converter 162 coupling the first rotating structure 44 and the second rotating structure 46 through the gear assembly 78. The torque converter 162 may be configured as a hydrodynamic torque converter forming a fluid (e.g., hydraulic) coupling between the first gear shaft 82 and the second gear shaft 84 (FIG. 7) or between the third gear shaft 138 and the fourth gear shaft 140. The torque converter 162 may be configured to transfer power from the second rotating structure 46 to the first rotating structure 44 through the gear assembly 78 (e.g., the torque converter 162 may be a unidirectional torque converter). The torque converter 162 may alternatively be converter to transfer power, through the gear assembly 78, from the first rotating structure 44 to the second rotating structure 46 and from the second rotating structure 46 to the first rotating structure 44 (e.g., the torque converter 162 may be a bidirectional torque converter). Similar to the continuously variable transmission 106, the torque converter 162 is operable in a zero-power transfer state.

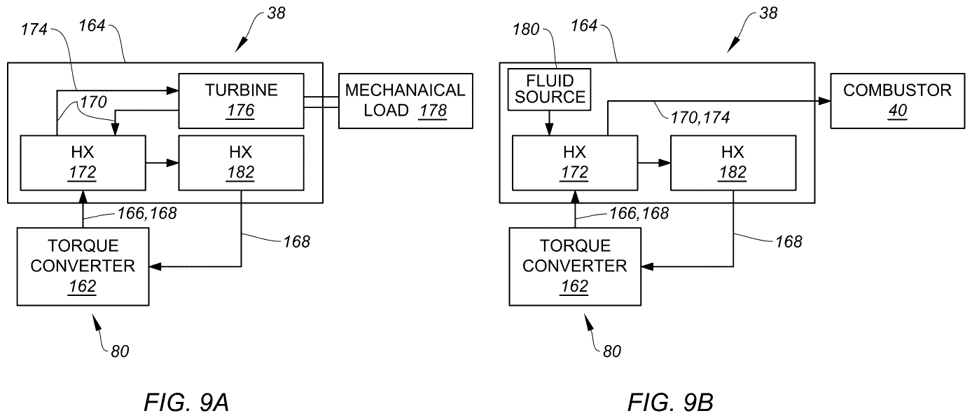

With further reference to FIGS. 7 and 8, in some embodiments, the transmission system 38 may additionally include a waste heat recovery system 164 connected in fluid communication with the torque converter 162. Operation of the torque converter 162 to transfer power from the first rotating structure 44 to the second rotating structure 46 and/or from the second rotating structure 46 to the first rotating structure 44 may cause the torque converter 162 to generate a substantial amount of heat energy in a hydraulic fluid 166 (e.g., oil) of the torque converter 162. The waste heat recovery system 164 is configured to recovery at least a portion of this heat energy from the hydraulic fluid 166 and convert the heat energy to mechanical power, electrical power, or to another output operable to facilitate improved power output and/or efficiency of the gas turbine engine 22. FIGS. 9A-B schematically illustrate various exemplary configurations of the waste heat recovery system 164. The waste heat recovery system 164 forms a hydraulic fluid flow path 168 with the torque converter 162. The waste heat recovery system 164 additionally forms a secondary fluid flow path 170 separated from fluid communication with the hydraulic fluid flow path 168. The waste heat recovery system 164 includes a heat exchanger 172 which forms portions of each of the hydraulic fluid flow path 168 and the secondary fluid flow path 170. The heat exchanger 172 is configured to transfer heat energy from the hydraulic fluid 166 in the hydraulic fluid flow path 168 to a secondary fluid 174 (e.g., water) in the secondary fluid flow path 170.

As shown in FIG. 9A, the waste heat recovery system 164 may include a recovery turbine 176 forming a portion of the secondary fluid flow path 170 (e.g., a closed-loop flow path in FIG. 9A). As the secondary fluid 174 passes through the heat exchanger 172, the heat energy added to the secondary fluid 174 may effect a liquid-to-gas phase change in the secondary fluid 174, and the resultant gas (e.g., steam) may be directed through the recovery turbine 176 along the secondary fluid flow path 170 to drive the recovery turbine 176. The recovery turbine 176 (e.g., a rotor of the recovery turbine 176) is coupled with a mechanical load 178 and configured to drive the mechanical load 178 in response to the secondary fluid 174 flow through the recovery turbine 176. In one example, the mechanical load 178 may be a rotor of an electrical generator configured to generate electrical power for an aircraft electrical system. In another example, the mechanical load 178 may include the accessory gear assembly 128. The present disclosure is not limited to any particular mechanical load of the recovery turbine 176. As shown in FIG. 9B, the waste heat recovery system 164 may direct the secondary fluid 174 from a fluid source 180 to the combustor 40 along the secondary fluid flow path 170 (e.g., an open-loop flow path in FIG. 9B). As the secondary fluid 174 passes through the heat exchanger 172, the heat energy added to the secondary fluid 174 may effect a liquid-to-gas phase change in the secondary fluid 174, and the resultant gas (e.g., steam) may be directed into the combustor 40 to facilitate improved power output and/or efficiency of the gas turbine engine 22 combustion process. In some embodiments, the waste heat recovery system 164 may include one or more additional heat exchangers 182 configured to further thermally condition the hydraulic fluid 166 along the hydraulic fluid flow path 168. Examples, of the heat exchangers 182 include, but are not limited to, air-to-oil heat exchangers, fuel-to-oil heat exchangers, oil-to-oil heat exchangers, and the like. The present disclosure, however, is not limited to the particular waste heat recovery system 164 configurations of FIGS. 9A and 9B.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

The terms “substantially,” “about,” “approximately,” and other similar terms of approximation used throughout this patent application are intended to encompass variations or ranges that are reasonable and customary in the relevant field. These terms should be construed as allowing for variations that do not alter the basic essence or functionality of the invention. Such variations may include, but are not limited to, variations due to manufacturing tolerances, materials used, or inherent characteristics of the elements described in the claims, and should be understood as falling within the scope of the claims unless explicitly stated otherwise.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

1. An aircraft propulsion system comprising:
a gas turbine engine comprising a first rotating structure and a second rotating structure, the first rotating structure comprising a bladed first compressor rotor, a bevel gear and a bladed first turbine rotor, the second rotating structure comprising a bladed second turbine rotor;
a transmission system comprising a gear assembly and a transmission, the gear assembly comprising a first gear shaft and a second gear shaft, the first gear shaft and the second gear shaft having a concentric configuration, the first gear shaft and the second gear shaft rotatable about a common lengthwise axis, the first gear shaft coupled between the first rotating structure and the transmission, the first gear shaft meshed with the bevel gear, the second gear shaft coupled between the second rotating structure and the transmission, the transmission configurable in at least a first power transfer state and a second power transfer state, the transmission in the first power transfer state transferring power from the second rotating structure to the first rotating structure, the second power transfer state being a zero-power transfer state; and
an accessory gear train and at least one accessory load, the accessory gear train coupling the at least one accessory load with the first rotating structure, and the accessory gear train meshed with the bevel gear independent of the gear assembly.

2. The aircraft propulsion system of claim 1, wherein the transmission is further configurable in a third power transfer state, and the transmission in the third power transfer state transfers power from the first rotating structure to the second rotating structure.

3. The aircraft propulsion system of claim 1, further comprising a propulsor rotor coupled with the second rotating structure.

4. The aircraft propulsion system of claim 3, wherein the gas turbine engine further comprises a fan case circumscribing the propulsor rotor, and the transmission is mounted on the fan case.

5. The aircraft propulsion system of claim 1, wherein the transmission comprises a gear-based continuous variable transmission coupling the first gear shaft and the second gear shaft, the gear-based continuous variable transmission configurable in a freewheeling condition in the zero-power transfer state.

6. The aircraft propulsion system of claim 1, wherein the transmission comprises a hydrodynamic torque converter coupling the first gear shaft and the second gear shaft.

7. The aircraft propulsion system of claim 6, wherein the transmission system further comprises a waste heat recovery system, the waste heat recovery system comprises a heat exchanger, and the heat exchanger and the hydrodynamic torque converter form a hydraulic fluid flow path.

8. The aircraft propulsion system of claim 7, wherein the waste heat recovery system further comprises a turbine, the turbine and the heat exchanger form a secondary fluid flow path, and the turbine is coupled with a mechanical load of the gas turbine engine.

9. The aircraft propulsion system of claim 7, wherein the gas turbine engine further comprises a combustor, the waste heat recovery system further comprises a secondary fluid flow path, the heat exchanger forms a portion of the secondary fluid flow path, and the secondary fluid flow path extends from the heat exchanger to the combustor.

10. (canceled)

11. The aircraft propulsion system of claim 1, wherein the gear assembly further comprises a third gear shaft and a fourth gear shaft, the third gear shaft and the fourth gear shaft have a second concentric configuration, the third gear shaft and the fourth gear shaft are rotatable about a second common lengthwise axis, the third gear shaft coupled between the first gear shaft and the transmission, and the fourth gear shaft is coupled between the second gear shaft and the transmission.

12. The aircraft propulsion system of claim 11, further comprising an accessory gear train and at least one accessory load, the accessory gear train coupling the at least one accessory load with the third gear shaft.

13. The aircraft propulsion system of claim 12, wherein the third gear shafts extends through the transmission between the first gear shaft and the accessory gear train.

14. The aircraft propulsion system of claim 11, wherein the second common lengthwise axis is orthogonal to the common lengthwise axis.

15. An aircraft propulsion system comprising:
a gas turbine engine comprising a first rotating structure and a second rotating structure, the first rotating structure comprising a bladed first compressor rotor, a bladed first turbine rotor, and a first gear, the second rotating structure comprising a bladed second turbine rotor and a second gear;
a transmission system comprising a gear assembly and a transmission, the gear assembly comprising a first gear shaft and a second gear shaft, the first gear shaft coupled between the first rotating structure and the transmission, the first gear shaft engaged with the first gear, the second gear shaft coupled between the second rotating structure and the transmission, the second gear shaft engaged with the second gear; and
an accessory gear train and at least one accessory load, the accessory gear train coupled between the first rotating structure and the at least one accessory load, the accessory gear train meshed with the first gear independent of the gear assembly.

16. The aircraft propulsion system of claim 15, further comprising a propulsor rotor, the gas turbine engine further comprising a fan case circumscribing the propulsor rotor, the transmission mounted on the fan case.

17. The aircraft propulsion system of claim 16, wherein the accessory gear train comprises an accessory gear box, and the accessory gear box is mounted on the fan case.

18. The aircraft propulsion system of claim 15, wherein the first gear shaft and the second gear shaft have a concentric configuration, and the first gear shaft and the second gear shaft are rotatable about a common lengthwise axis.

19. An aircraft propulsion system comprising:
a gas turbine engine comprising a first rotating structure and a second rotating structure, the first rotating structure comprising a bladed first compressor rotor and a bladed first turbine rotor, the second rotating structure comprising a bladed second turbine rotor;
a transmission system comprising a gear assembly and a transmission, the gear assembly comprising a first gear shaft and a second gear shaft, the first gear shaft coupled between the first rotating structure and the transmission, the first gear shaft extending radially between and to a first inner end and a first outer end, the first inner end disposed at the first rotating structure, the first outer end disposed at the transmission, the second gear shaft coupled between the second rotating structure and the transmission, the second gear shaft extending radially between and to a second inner end and a second outer end, the second inner end disposed at the second rotating structure, the second outer end disposed at the transmission; and
an accessory gear train and at least one accessory load, the accessory gear train coupled between the first rotating structure and the at least one accessory load independent of the gear assembly.

20. The aircraft propulsion system of claim 19, wherein the transmission is configurable in at least a first power transfer state and a second power transfer state, the transmission in the first power transfer state transfers power from the second rotating structure to the first rotating structure, and the second power transfer state is a zero-power transfer state.
